(19) United States
(12) Patent Application Publication
(10) Pub. No.: US 2008/0292835 A1
(43) Pub. Date: Nov. 27, 2008

(54) Methods for forming freestanding nanotube objects and objects so formed

(76) Inventors: Lawrence Pan, Palo Alto, CA (US); Bert Fornaciari, Palo Alto, CA (US)

Correspondence Address: PATENTBEST, 4600 ADELINE ST., #101, EMERYVILLE, CA, 94608, US

(21) Appl. No.: 11/897,893

(22) Filed: Aug. 30, 2007

Related U.S. Application Data
(60) Provisional application No. 60/841,266, filed on Aug. 30, 2006.
(60) Provisional application No. 60/876,336, filed on Dec. 21, 2006.
(60) Provisional application No. 60/923,904, filed on Apr. 17, 2007.

(51) Int. Cl. B05D 3/12; B32B 5/00; B32B 37/00

(52) U.S. Cl. 428/98; 427/197; 156/243; 977/742

(57) ABSTRACT

Methods for forming freestanding objects primarily comprising aligned carbon nanotubes, as well as the objects made by these methods, are provided. Arrays of generally aligned carbon nanotubes are first synthesized on a substrate then released from the substrate and densified, maintaining the aligned arrangement. These densified arrays can take the form of thin strips which can be joined together, for example by lamination, to form larger objects of arbitrary size. These objects can be further cut or otherwise machined to desired dimensions and shapes. Release from the substrate can be accomplished mechanically, such as by shearing, or chemically, such as by etching. Densification can be accomplished, for example, through compaction or by taking advantage of capillary forces. In the latter case, an array is first wetted with a fluid and then dried. As the fluid is removed, capillary forces draw the nanotubes closer together.

### CROSS REFERENCE TO RELATED APPLICATIONS

This application claims the benefit of U.S. Provisional Patent Application 60/841,266 filed Aug. 30, 2006 and titled “Control and Increase of the Density of Vertically Aligned Carbon Nanotubes;” U.S. Provisional Patent Application 60/876,336 filed Dec. 21, 2006 and titled “Increase of the Density of Vertically Aligned Carbon Nanotubes; and U.S. Provisional Patent Application 60/923,904 filed Apr. 17, 2007 and also titled “Increase of the Density of Vertically Aligned Carbon Nanotubes;” each of which is incorporated herein by reference.

### STATEMENT REGARDING FEDERALLY SPONSORED RESEARCH OR DEVELOPMENT

This invention was made with United States Government support under SBIR Contract # 0422198 from the National Science Foundation. The United States has certain rights in the invention.

### BACKGROUND

1. Technical Field

The present invention relates generally to the formation of freestanding objects made from nanotubes.

2. Related Art

The unique properties of nanotubes, especially carbon nanotubes, have resulted in attempts to use nanotubes in a variety of different applications. In many of these applications, a body of relatively dense nanotubes is desired. For example, an application using nanotubes to store a chemical or electrical species may have a constraint on the maximum size of the storage container, and the user desires the maximum storage within this volume. Thermal management applications may also require a high density of nanotubes, and these latter applications may also require an aligned body of nanotubes. In these and other applications, a maximum density of nanotubes is desired.

However, synthesis methods for nanotubes often result in arrays or other sets of nanotubes having a relatively low packing density of nanotubes in the array or set (e.g. for carbon nanotubes, sometimes below 1% of the theoretical density of graphite). For chemical vapor deposition (CVD) growth of nanotubes on a substrate, a low nanotube density may even enhance growth rates by allowing gases to easily pass through the tubes to the tube/substrate interface where growth occurs.

Thus, a method for forming nanotubes into relatively high density objects is desired.

### SUMMARY OF THE INVENTION

An exemplary method for forming nanotubes into a freestanding object comprises providing a substrate having a surface, growing an array of substantially aligned nanotubes on the surface, separating at least a portion of the array from the surface to form a separated portion, and densifying the separated portion to form the freestanding object. The array is characterized by a height in a direction normal to the surface. Select embodiments include forming a catalyst layer on the surface, and in some cases this catalyst may be patterned, creating regions where nanotubes grow preferentially. These regions may be characterized by at least one length, in a direction parallel to the surface. In certain embodiments, an array of nanotubes is grown such that the height of the array is approximately equal to or greater than the length of the region defining the array.

Separation of all or part of the array from the substrate may include the use of mechanical forces and/or chemical etching of the interface between the nanotubes and the surface. Densification may include mechanically compacting the separated portion, including the application of forces parallel to and/or perpendicular to the alignment of the nanotubes in the portion. Densification may also include constraining one or more sides of the portion during compaction. In certain embodiments, separation and densification may be performed at essentially the same time. In select embodiments, densification may be performed by wetting and drying the portion. Wetting may be accomplished by exposing the portion to a fluid, mist, or vapor, and in some aspects, wetting includes exposure to isopropyl alcohol. Drying may include constraining one or more sides of the portion. In some embodiments, densification may include the combination of mechanical forces with wetting and drying the portion.

Another exemplary method of the invention is directed to forming nanotubes into a first object. In this method a plurality of second objects are formed by providing a substrate including a surface, growing an array of substantially aligned nanotubes on the surface, separating at least a portion of the array from the surface to form a separated portion, and densifying the separated portion to form the second object. The plurality of second objects are then assembled together to form the first object. In various embodiments at least one of the second objects and/or the first object can be trimmed. Assembling the plurality of second objects together to form the first object can include, in some instances, the use of a glue or an adhesive.

An object comprised of nanotubes is also provided. In some embodiments, an object may be comprised of at least 90% nanotubes by mass, and have a density greater than 0.4 grams/cc, and have a volume greater than 5 cubic millimeters. In certain embodiments, an object is comprised of at least 10%, or even at least 60% nanotubes by mass, and has a volume greater than 5 cubic millimeters.

### BRIEF DESCRIPTION OF THE DRAWINGS

FIG. 1 is a flowchart generally illustrating a method for forming a freestanding nanotube object according to an exemplary embodiment of the invention.

FIGS. 2A-2C schematically show exemplary steps for providing a substrate according to an exemplary embodiment of the invention.

FIG. 3 schematically shows an array of substantially aligned nanotubes on a surface of a substrate according to an exemplary embodiment of the invention.

FIG. 4A schematically shows a portion of an array separated from the surface according to an exemplary embodiment of the invention.

FIG. 4B schematically illustrates a method for mechanically separating and densifying a portion of an array according to an exemplary embodiment of the invention.

FIG. 5 schematically illustrates a process for densifying an array of nanotubes according to an exemplary embodiment of the invention.

FIG. 6 schematically illustrates steps of a method for partially densifying a wet nanotube array prior to drying, according to an exemplary embodiment of the invention.

FIGS. 7A-7D show examples of assemblages constructed from densified nanotube arrays, according to exemplary embodiments of the invention.

FIGS. 8A and 8B schematically illustrate another exemplary method for creating an assemblage, according to an exemplary embodiment of the invention.

FIG. 9 shows a graphical representation of nanotube diameter, nanotube wall thickness, and nanotube density for four exemplary catalysts.

### DETAILED DESCRIPTION OF THE INVENTION

The specification provides methods for forming freestanding objects formed primarily from aligned carbon nanotubes, as well as the objects made by these methods. In these methods, arrays of generally aligned carbon nanotubes are first synthesized and then densified, maintaining the aligned arrangement. The densified arrays can take the form of thin strips which can be joined together, for example by lamination, to form larger objects of arbitrary size. These objects can be further cut or otherwise machined to desired dimensions and shapes.

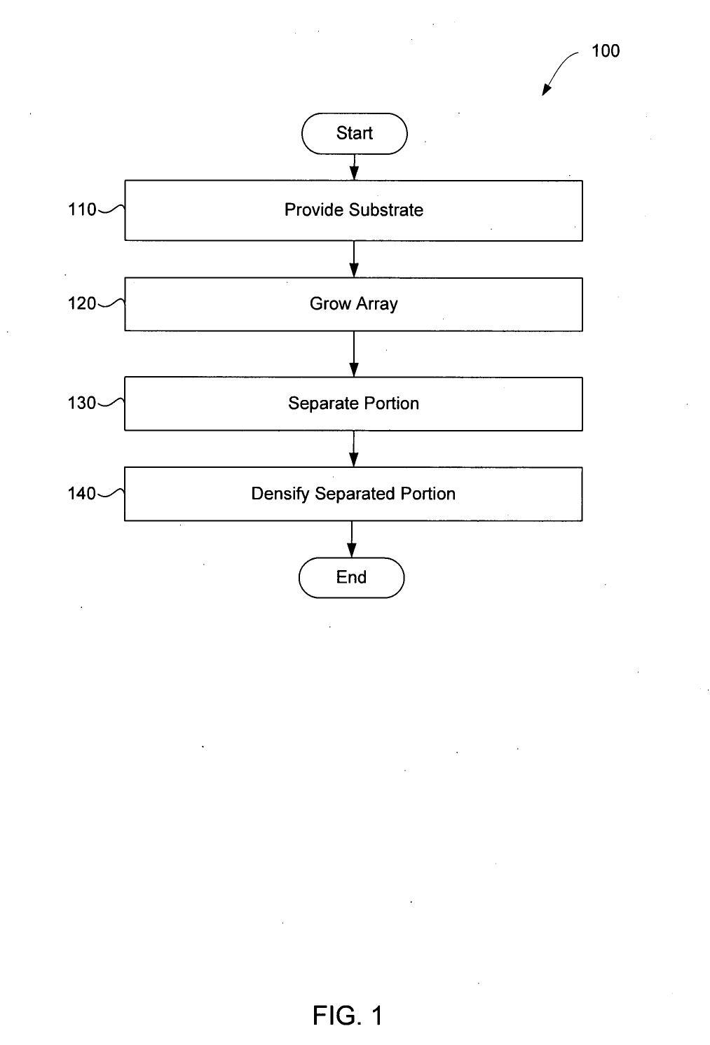

FIG. 1 shows a flowchart 100 that provides an overview of an exemplary embodiment of the invention. In a Step 110, a suitable substrate is provided for the growth of nanotubes. In a Step 120, one or more nanotube arrays are grown on the surface of the substrate. Step 130 comprises separating at least a portion of an array from the substrate, and Step 140 comprises densifying the separated portion. In general, the steps of providing the substrate and growing the one or more arrays of nanotubes are performed prior to the steps of separation and densification. In different embodiments, the step of densification follows the step of separation, the step of densification starts before the step of separation is completed, or the two steps are performed simultaneously.

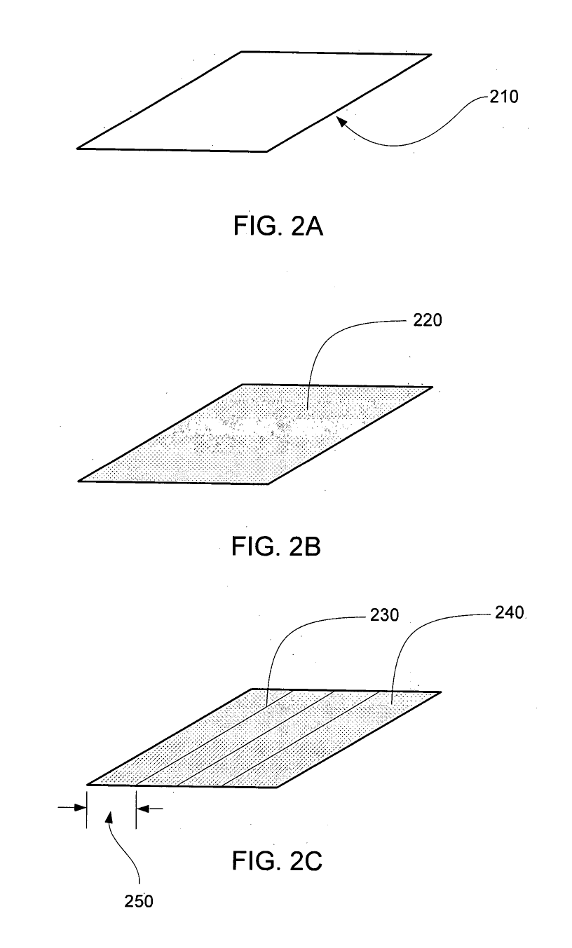

FIGS. 2A-2C illustrate exemplary steps of the Step 110 (FIG. 1) of providing the substrate. In FIG. 2A, Substrate 210 is a suitable substrate for the growth of nanotubes. For the purposes of the Step 120 (FIG. 1), in which a high temperature process such as chemical vapor deposition (CVD) is used to grow one or more arrays of refractory nanotubes such as carbon nanotubes, Substrate 210 can be composed of a refractory material such as Si, SiO₂, or Al₂O₃. It will be appreciated that although Substrate 210 is shown in FIGS. 2A-2C as flat, the Substrate 210 is not limited to being flat.

As shown in FIG. 2B, Substrate 210 is provided with an Active Surface 220 on which the one or more arrays of nanotubes will be grown in Step 120. The Active Surface 220 can cover the entire surface of the Substrate 210 as shown, or can be limited to portions of the surface of the Substrate 210, as discussed below in connection with FIG. 2C. Because nanotube growth can be sensitive to the composition and morphology of the Active Surface 220, preparing the Active Surface 220 can optionally include cleaning the surface of the Substrate 210 and/or providing a catalyst layer on the surface of the Substrate 210 to enhance growth. An exemplary cleaning procedure for silicon substrates includes immersion for 10 minutes in a 4:1 bath of H₂SO₄/H₂O₂, maintained at 120° C. The Substrate 210 is then rinsed in water and immersed for 10 minutes in a 5:1:1 bath of H₂O/H₂O₂/HCl, maintained at 90° C. The Substrate 210 is then rinsed in water and immersed for 1 minute in a 50:1 HF:H₂O room temperature bath. The Substrate 210 is then rinsed in water and spun dry.

Exemplary catalysts for carbon nanotube synthesis are well known and include Fe, Co, Ni, Mo and oxides thereof. In some embodiments, providing the catalyst layer on the surface of the Substrate 210 includes creating small (e.g. <100 nm) catalyst particles on the Active Surface 220. Techniques such as physical vapor deposition (PVD) followed by annealing can be used to create these particles. U.S. Pat. No. 7,235,159 “Methods for Producing and Using Catalytic Substrates for Carbon Nanotube Growth” discloses several methods.

In some aspects that include providing the catalyst layer, the Active Surface 220 is enhanced by forming one or more interfacial layers between the Substrate 210 and the catalyst layer. For example, an interfacial layer can comprise about a 10-150 nm thick Al₂O₃ layer between the catalyst layer and the surface of the Substrate 210. Another interfacial layer can comprise an approximately 500 nm thick SiO₂ layer disposed between the Al₂O₃ layer and the Substrate 210.

In some aspects, providing the catalyst layer includes depositing a thin layer of a catalyst material on the Substrate 210 through the use of electron beam evaporation followed by annealing the Substrate 210. Exemplary catalysts can comprise Fe, Co, Ni, Mo, Ru and combinations thereof. Suitable thicknesses of the deposited layer are between 0.1 nm and 5 nm, and preferably between 1 nm and 3 nm.

Providing the catalyst layer, in some embodiments, can comprise sequentially depositing multiple layers of catalyst, optionally with an intermediary processing step between layers to effect a chemical or physical change in the initially deposited layer or layers prior to the deposition of a subsequent layer. Examples of such a multilayer deposition process include depositing a 1 nm Fe layer followed by an anneal and then by depositing another 1 nm Fe layer (1 nm Fe/anneal/1 nm Fe); 1 nm Fe/anneal/1 nm Co; and 1 nm Co/anneal/1 nm Fe. An appropriate anneal may be performed at temperatures between about 600 and 900° C., and more preferably between about 700 and 800° C. For an annealing tube furnace having a 6″ diameter tube, an appropriate ambient comprises 2.5 standard liters per minute of ultra high purity argon, with a ramp rate of 15° C./minute and virtually no dwell time at the desired maximum annealing temperature.

The Active Surface 220 may optionally be patterned, creating Boundaries 230 that define bounded Regions 240, as shown in FIG. 2C. A Boundary 230 may be straight, curved, angled, continuous, discontinuous, regular or irregular. Although shown as a line in FIG. 2C, the Boundary 230 can have an appreciable width to separate one Region 240 from the next. An exemplary Region 240 is rectangular, as shown, but is not so limited.

Nanotube growth on or within a Boundary 230 may be prevented or minimized by not applying a catalyst to the surface of the Substrate 210 on the Boundary 230. In some aspects, the Substrate 210 can be masked, then subject to a line of sight deposition technique (e.g. PVD) for deposition of a catalyst. Here, the masked regions do not receive deposited catalyst, while the regions exposed to the catalyst deposition become the Regions 240 that comprise the Active Surface 220. Contact masks, lithography, and other masking methods can be used to demarcate Boundaries 230.

An exemplary photolithography method includes coating a silicon wafer with a 1 μm positive photoresist layer, baking the resist, masking the resist using an appropriate mask, exposing the resist, developing the resist, dissolving the exposed portion (or unexposed, if using a negative resist), and optionally inspecting the wafer. Following catalyst deposition, the remaining resist is lifted off (e.g. via an acetone soak, optionally including surface swabbing) followed by an acetone rinse and an isopropanol rinse, followed by drying in nitrogen.

For the purposes of this specification, a Region 240 is any contiguous area on the surface of the Substrate 210 where nanotubes are intended to grow in Step 120. If no Boundaries 230 are present, the entire surface of the Substrate 210 will define a single unbounded Region 240. If Boundaries 230 are present, multiple discrete Regions 240 will exist on the surface of the Substrate 210. The number, size, shape and other aspects of each Region 240 may depend on the final application of the nanotubes fabricated thereon. In addition to the methods described above, Boundaries 230 can also be created after the formation of the Active Surface 220 (e.g. by masking followed by etching or ablating, or by targeted ablating of appropriate areas of the Active Surface 220).

Each Region 240 of the Active Surface 220 can be characterized by at least one Length 250 that is the smallest lateral dimension of the Region 240. As will be discussed later, Length 250 may correspond to the smallest lateral dimension of a nanotube array grown on that Region 240.

Methods for growing nanotubes, especially carbon nanotubes, are well known. For the purposes of the present invention, growth conditions that yield substantially aligned nanotubes are utilized for Step 120 (FIG. 1). For certain densification processes in Step 140 (FIG. 1), discussed below, in which separation of the nanotubes includes etching, it may be advantageous to choose a “base growth” method for growing the nanotubes (in which the nanotubes grow from the point of attachment to the catalyst) and to choose a catalyst that can be readily etched. Exemplary thermal CVD growth conditions for growing carbon nanotubes in a 1″ tube furnace include a temperature in the range of about 700-800° C. Substrates may be initially heated in an inert atmosphere (e.g. argon), then exposed to a deposition atmosphere comprising, for example, a hydrocarbon component. An exemplary deposition atmosphere includes 0.1 standard liters per minute (SLM) ethylene, 0.4 SLM hydrogen, and water vapor. An appropriate water vapor concentration may be created by bubbling 0.1 SLM of argon through a water bubbler at ambient temperature. Typical growth times are between 5 minutes and 100 minutes.

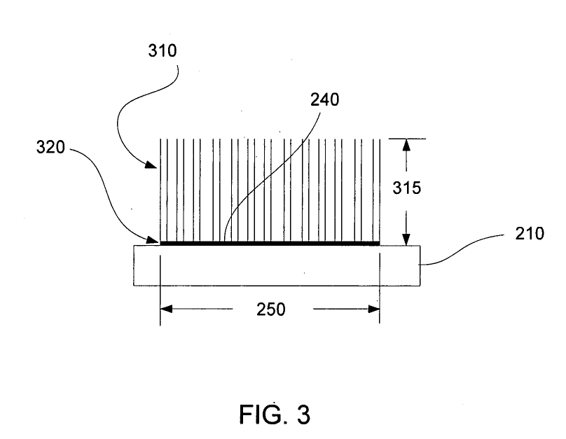

FIG. 3 schematically shows an exemplary nanotube array that may be grown according to exemplary embodiments of Step 120 (FIG. 1). As in FIGS. 2A-2C, the Substrate 210 includes a Region 240 having a Length 250. In Step 120 an Array 310 of nanotubes is grown on the Region 240 to an Array Height 315. Nanotubes in the Array 310 are connected to the Active Surface 220 at an Interface 320. It may be advantageous to grow the Array 310 to a sufficient Height 315 that the ratio of the Height 315 to the Length 250 is greater than 1:1. For thermal CVD growth of carbon nanotubes as described herein, 30 minutes of growth at 800° C. can yield an Array 310 having a Height 315 of approximately 1 mm or greater.

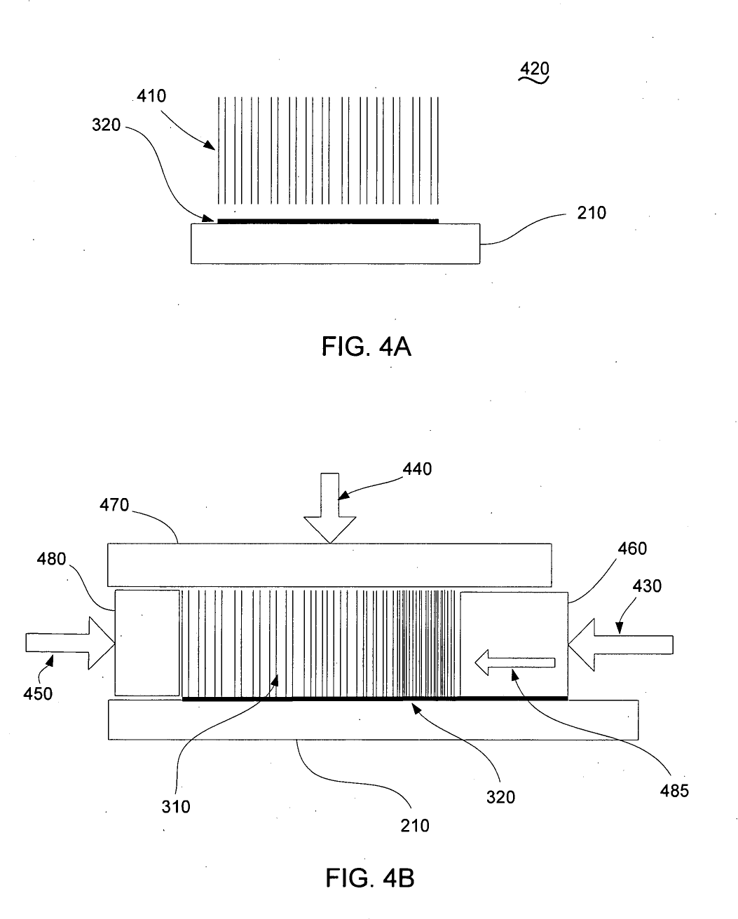

FIG. 4A schematically shows an exemplary result of separating a Portion 410 of the Array 310 from the Substrate 210 after Step 130 (FIG. 1). As shown, the Portion 410 can include the entire Array 310, while in some aspects the Portion 410 comprises some segment of the Array 310. For example, it may be advantageous to release all of the Array 310 except for one or more small attached sections at the edges, in order to keep the Array 310 loosely connected to the Substrate 210 for further processing.

In some embodiments, Step 130 is performed by introducing a suitable Separation Atmosphere 420 to the Substrate 210 and Array 310, where the Separation Atmosphere 420 is capable of etching the Interface 320 to release the Portion 410 from Substrate 210. Advantageously, in some embodiments the Step 120 of growing the Array 310 and the Step 130 of releasing at least the portion 410 of the Array 310 can be performed in the same reaction vessel. For example, the Separation Atmosphere 420 can be introduced into the reaction vessel (e.g., a tube furnace) immediately following the deposition atmosphere. An exemplary Separation Atmosphere 420 includes 0.5 SLM hydrogen and water carried on 0.1 SLM argon bubbled through a water bubbler at ambient temperature.

FIG. 4B schematically illustrates a method for concurrently separating and densifying a Portion 410 of an Array 310. In this example, the Portion 410 comprises the entire Array 310 which is subjected to Forces 430, 440, and 450 by Blocks 460, 470, and 480, respectively. For example, Force 430 is used to move the Block 460 in the direction 485, as shown, to mechanically shear the nanotubes of the Array 310 off of the Substrate 210. As the nanotubes of the Array 310 are separated from the Substrate 210 and densified through compaction against Block 480, the Force 450 increases against the Array 310. The Block 470 also exerts the Force 440 against the top of the Array 310 in order to resist buckling of the Array 310 in response to the Forces 430 and 440. While in the illustrated example the Block 480 is fixed and exerts the Force 450 reactively in response to the compaction of nanotubes against the Block 480, in some embodiments Blocks 460 and 480 are moved towards one another to compact the Array 310 from both sides.

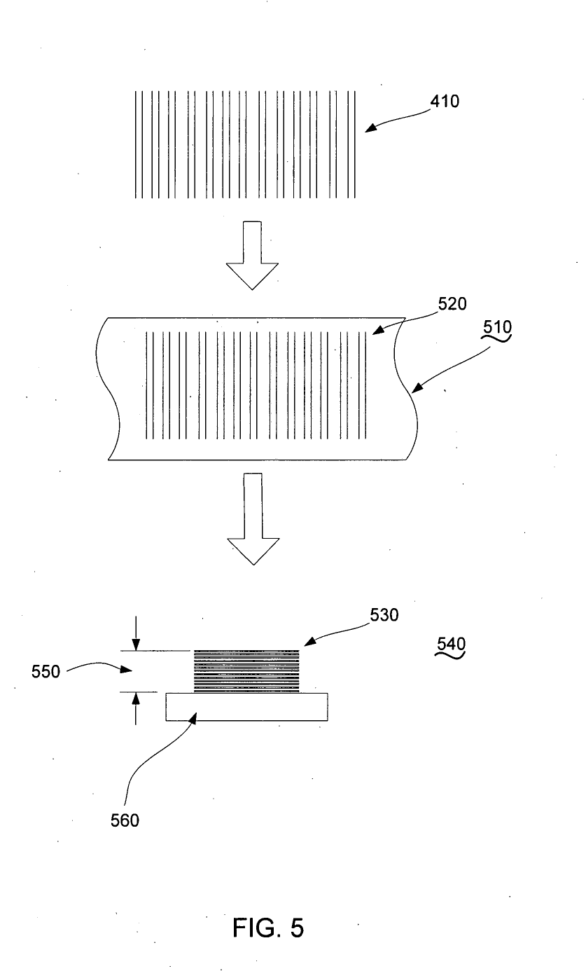

FIG. 5 schematically illustrates, for the Step 140 (FIG. 1), an exemplary method for densifying a Portion 410 that has been previously separated from the Substrate 210. In this method, the Portion 410 is first exposed to a Wetting Environment 510 to create a Wet Portion 520 that is subsequently dried to create a Densified Portion 530. When allowed to dry, capillary forces between nanotubes in the Wet Portion 520 draw the nanotubes closer together as the drying progresses.

The Wetting Environment 510 can comprise a wetting fluid and a type of exposure. For instance, the type of exposure can be immersion in the wetting fluid, exposure to a vapor including the wetting fluid, or exposure to a mist of the wetting fluid. A wetting fluid having at least some nonpolarity may be advantageous, and isopropyl alcohol (and solutions thereof) is a suitable example. Other suitable wetting fluids include water, xylene, acetone, methanol, and ethanol. The choice of a wetting fluid may also be partially influence by desired drying kinetics. Fluids with particularly low vapor pressures may dry too slowly; fluids with particularly high vapor pressures may dry too quickly (at a given drying condition of pressure and temperature).

One or more surfactants may also be added to the Wetting Environment 510. Surfactants may increase the wetting of the nanotubes by a particularly fluid. Surfactants may also substantially adhere to the nanotubes, and in some cases may create a degree of steric separation between tubes (e.g. surfactant molecules prevent two tubes from approaching closer than a certain distance). In certain aspects, this steric separation may be used to control a final density by maintaining a minimum separation between tubes or groups of tubes. Thus, a desired density may be achieved by balancing the compressive forces of the densification process with repulsive forces between tubes (e.g. by a surfactant), allowing a user to tailor the density to a target application. Certain embodiments may result nanotubes bodies having final mass densities between 2% and 97%, preferably between 5% and 90%, more preferably between 10% and 80%, and still more preferably between 15% and 70%. Sodium dodecylbenzene sulfonate can be a suitable surfactant for creating these steric forces.

As noted above, Portion 410 can be exposed directly to a liquid, for example, by immersion. In these embodiments the Portion 410 rapidly becomes saturated with the wetting fluid. Portion 410 can also be exposed to a mist or vapor such that the exposure begins gradually and increases until the Portion 410 is sufficiently wet. In some cases, complete saturation of Portion 410 (i.e. substantially filling all intertubular space with the wetting fluid) may not be necessary.

As shown in FIG. 5, Wet Portion 520 is exposed to a Drying Atmosphere 540 to produce the Densified Portion 530. Where the wetting fluid is isopropyl alcohol, for example, a Drying Atmosphere 540 comprising air at ambient temperature and pressure can produce the Densified Portion 530 within a few minutes. In some embodiments, drying the Wet Portion 520 results in the Densified Portion 530 having a Length 550 that is smaller than the corresponding Length 250 of the Portion 410 prior to densification. By gently wetting and drying the Portion 410, alignment of the nanotubes can be preserved to enhance densification, resulting in a Length 550 substantially smaller than the corresponding Length 250 of the Portion 410 prior to densification.

FIG. 5 shows the Densified Portion 530 disposed on a Drying Substrate 560, but it will be appreciated that the Drying Substrate 560 is not essential in some embodiments. For example, the Wet Portion 520 can be suspended in the Drying Atmosphere 540 by one end and allowed to densify. In some embodiments, however, it is advantageous to support and/or mold the Wet Portion 520 while disposed in the Wetting Environment 510 and/or the Drying Atmosphere 540. For instance, the Wet Portion 520 can be removed from the Wetting Environment 510 using a substrate, form, mandrel, mold or other support, which may also be used to mold, support and/or constrain Wet Portion 520 during the subsequent exposure to the Drying Atmosphere 540. The orientation of such a support (e.g. Drying Substrate 560) with respect to a supported portion can be such that the nanotubes are aligned substantially parallel to the support, substantially perpendicular to the support, or in any desired orientation. One or many portions may be supported by a single support, and the degree of alignment or randomness among portions can be tailored to a desired application. Appropriate materials for such a support include fused silica, Teflon, silicon, and silicone.

FIG. 5 shows an example in which the support comprises the Drying Substrate 560. It may be advantageous to fabricate the Drying Substrate 560 from an elastic material (e.g. rubber, latex, or silicone), which allows the Drying Substrate 560 to be stretched. By stretching Drying Substrate 560 prior to contact with the Wet Portion 520, Wet Portion 520 may be placed or molded onto the stretched Drying Substrate 560. Subsequently, releasing or relaxing the stretched Drying Substrate 560 during exposure to the Wetting Environment 510 and/or the Drying Atmosphere 540, or even after drying, will cause the Drying Substrate 560 to contract which may enhance the densification of the portion attached thereto. In some of these embodiments, the Wet Portion 520 is oriented on the Drying Substrate 560 such that the direction of alignment of the nanotubes is normal to the surface of the Drying Substrate 560, whereas in other embodiments the orientation of the Wet Portion 520 is as shown in FIG. 5.

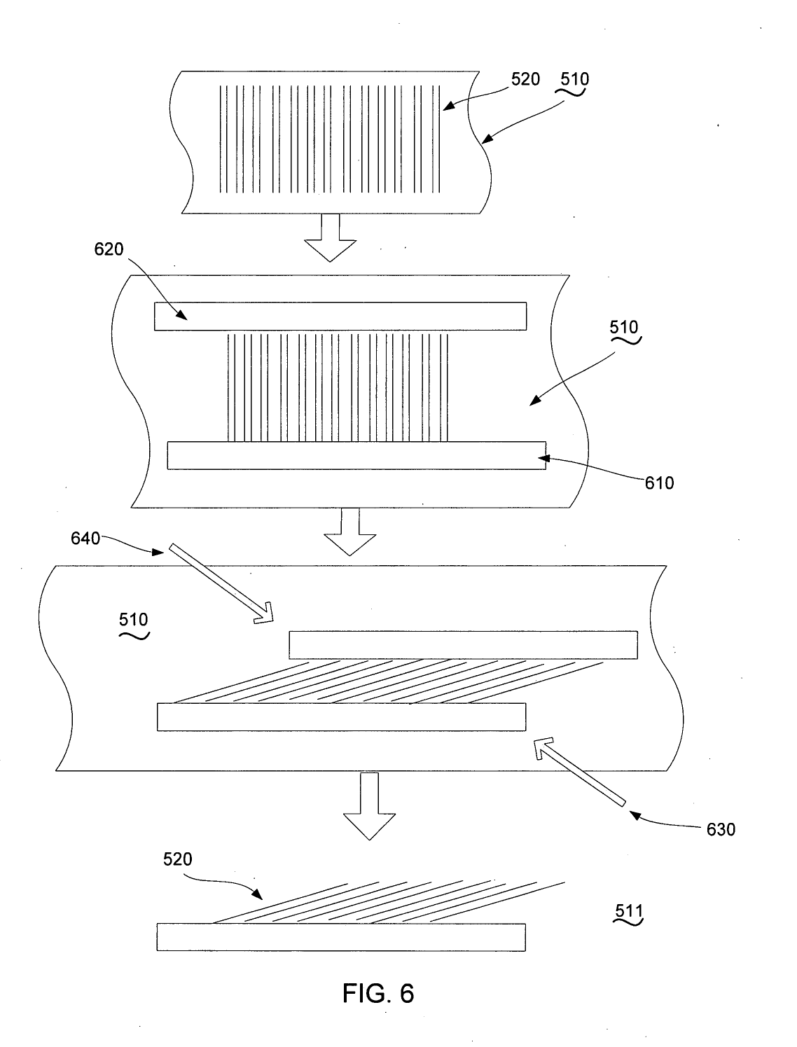

FIG. 6 illustrates steps of a method for partially densifying the Wet Portion 520 prior to drying. In this example, Wet Portion 520, while exposed to Wetting Environment 510, is disposed between Blocks 610 and 620 as shown. Blocks 610 and 620 are then actuated to apply Forces 630 and 640 to compress and shear the Wet Portion 520. In this way the nanotubes of the Wet Portion 520 “lay down” with respect to their initial alignment as illustrated while maintaining the substantially parallel alignment that existed prior to the application of Forces 630 and 640. While the Forces 630 and 640 already include a compressive component, further densification can be achieved by applying additional compression, without the shear component, after the application of Forces 630 and 640.

Following the mechanical manipulation shown in FIG. 6, the nanotubes are exposed to the Drying Atmosphere 540, discussed above, to create the Densified Portion 530. One or both of Blocks 610 and/or 620 can be removed prior to the exposure to the Drying Atmosphere 540. Optionally, either or both of the Blocks 610 and 620 can comprise a shaped surface against which the Wet Portion 520 can be molded during the process illustrated by FIG. 6 and/or during the subsequent drying process.

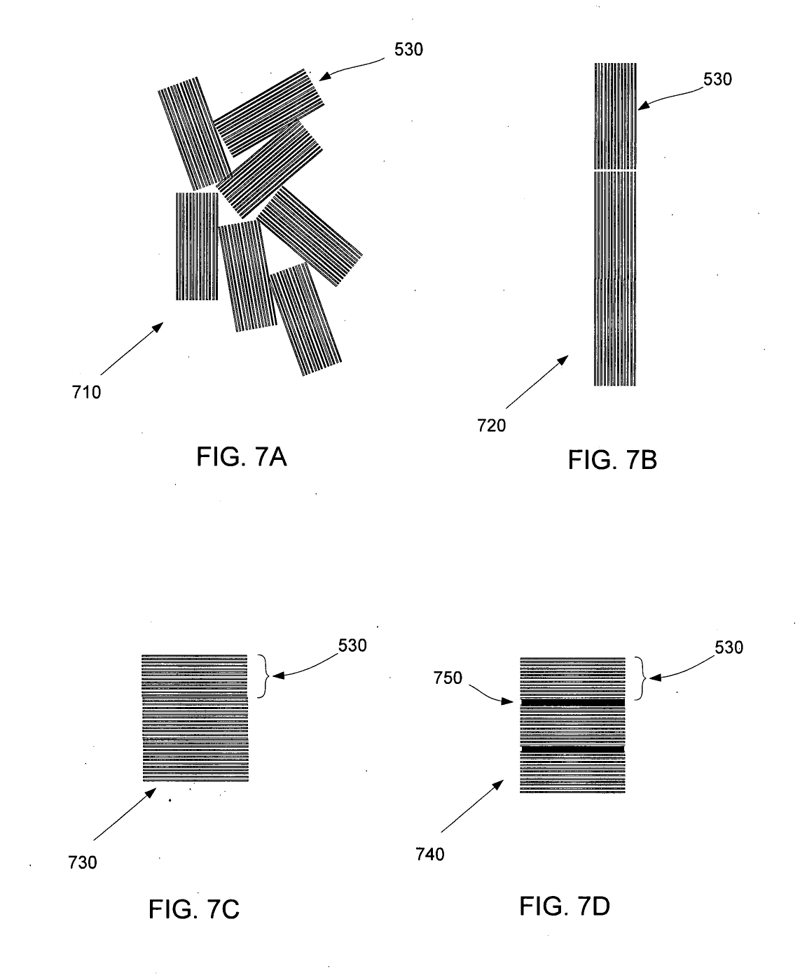

FIGS. 7A-7D show examples of freestanding assemblages constructed from Densified Portions 530 according to various embodiments. These examples are illustrative, and not meant to be limiting.

Assemblage 710, shown in FIG. 7A, comprises multiple Densified Portions 530, arranged in an ostensibly random fashion. Although FIG. 7A shows the Densified Portions 530 each having a direction of nanotube alignment that is in the plane of the drawing page, it will be appreciated that the direction of nanotube alignment for the multiple Densified Portions 530 can be randomly oriented in three dimensions as well. In some instances, Assemblage 710 may be constrained within a package such as a can or an envelope. In these embodiments, the multiple Densified Portions 530 can be loosely arranged or packed for greater density. In some cases the package can be the support discussed above with respect to FIG. 5.

FIG. 7B shows an Assemblage 720 that comprises multiple Densified Portions 530 arranged “end to end” such that the longitudinal direction of the nanotubes (the direction of nanotube alignment) is substantially maintained throughout the Assemblage 720. In some embodiments, the multiple Densified Portions 530 are joined together by a bonding agent such as a glue or an adhesive. Exemplary glues and adhesives include cyanoacrylates and methacrylate esters such as Loctite® formulations 262, 271, 290, 609 and 680.

FIGS. 7C and 7D show Assemblages 730 and 740, respectively, each comprising multiple Densified Portions 530 arranged such that the longitudinal direction of the nanotubes is substantially parallel for each Densified Portion 530. Assemblages 730 and 740 can be created by stacking Densified Portions 530 as shown. Assemblage 740 further comprises a Bonding Agent 750 such as adhesive or glue, while Assemblage 730 does not.

Any of the Assemblages 710-740 can additionally be further densified, e.g. by the application of a compressive force. Additionally, any of the Assemblages 710-740 can be trimmed by cutting or machining to a desired dimension or shape. Assemblages 710-740 can also be further joined together to form still larger freestanding structures comprised essentially of only nanotubes. Further still, any of the Assemblages 710-740 can be laminated with layers of other materials. For example, ceramic or metallic layers may be combined with nanotube layers for added stiffness.

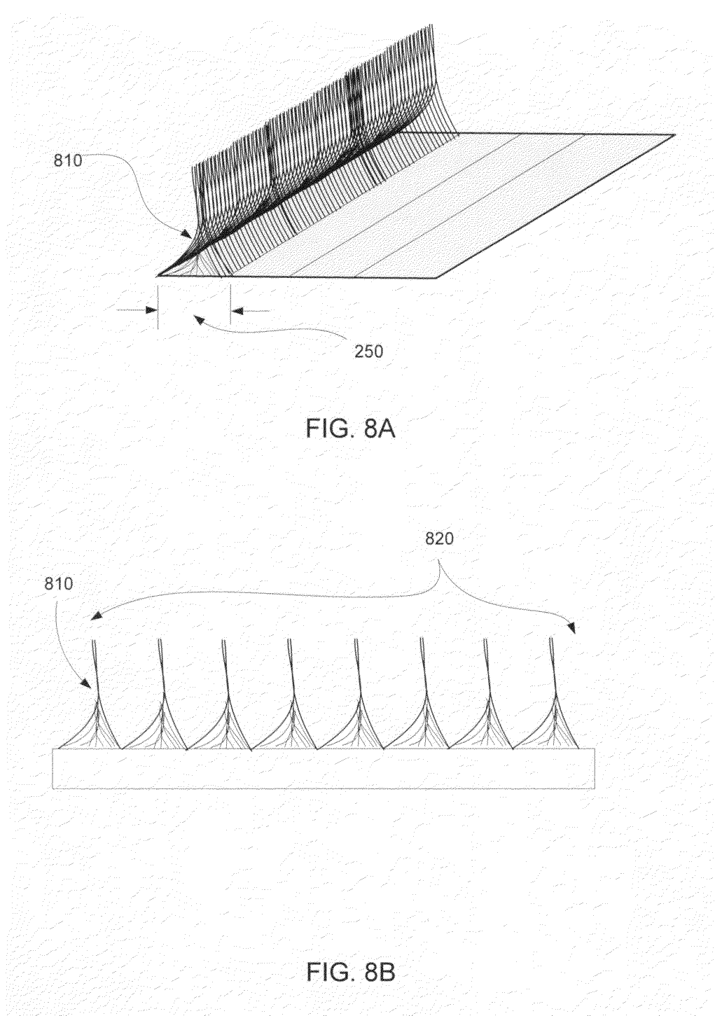

FIGS. 8A and 8B illustrate another exemplary method for creating an assemblage. In FIG. 8A an active surface of a substrate is patterned and used to grow parallel Arrays 810 of generally vertically aligned nanotubes. Here, a Length 250 for each Array 810 is chosen to be about equal to the expected Height 315 of the Arrays 810. The final lateral dimension of the Arrays 810 on the surface (i.e. perpendicular to Length 222 and Height 314) can be made arbitrarily large. While the Arrays 810 are still attached to the active surface, the Arrays 810 can be wetted and dried wet, resulting in a structure as depicted in FIG. 8B, in which the Arrays 810 form Rows 820 of at least partially densified nanotubes. The Rows 820 can be mechanically separated from the substrate and further densified according to the method illustrated with respect to FIG. 4B, for example. The Rows 820 can also be at least partially separated from the substrate by etching prior to mechanical compression as discussed with respect to FIG. 4A.

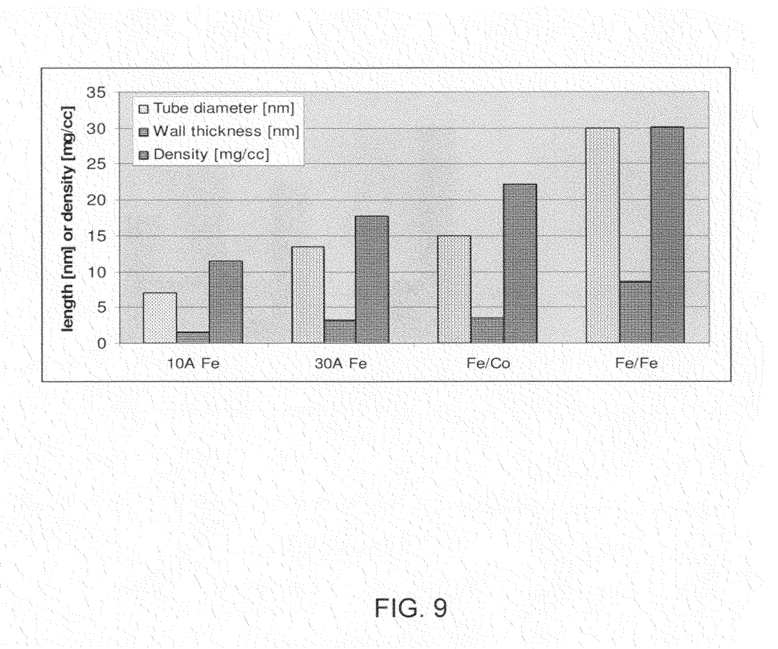

Although several aspects of the invention address the densification of an as-grown nanotube array, for some applications it may also be advantageous to increase the densities of the individual nanotubes within an array and/or increase the number of nanotubes per unit area in the as-grown array. The density of each nanotube (essentially a function of the nanotube wall thickness), and the number of nanotubes per unit area in the as-grown array can both be sensitive to several factors including the catalyst composition, distribution on the active surface, and the growth environment. FIG. 9 provides a graphical representation of how nanotube diameter, nanotube wall thickness, and nanotube density within an array can vary for four exemplary catalysts.

As noted above, the invention also includes freestanding objects comprised of aligned and densified nanotubes. In some embodiments, such freestanding objects have a volume of greater than 5 cubic millimeters and comprise at least 10% nanotubes by mass. In further embodiments, a freestanding object can comprise at least 60% nanotubes by mass, and even at least 90% nanotubes by mass. In some of these embodiments, the objects have a density greater than 0.4 grams/cc.

### EXAMPLE 1

A 4″ single crystal silicon substrate was cleaned by immersion in a 4:1 bath of H₂SO₄/H₂O₂, maintained at 120° C., for 10 minutes. The substrate was then rinsed in water and immersed in a 5:1:1 bath of H₂O/H₂O₂/HCl, maintained at 90° C., for 10 minutes. The substrate was then rinsed in water and immersed in a 50:1 HF:H₂O bath, at room temperature, for 1 minute. The substrate was then rinsed in water and spun dry.

500 nm of SiO₂ was thermally grown on the cleaned substrate followed by 20 nm Al₂O₃ deposited by sputtering from an Al₂O₃ target. Straight, 12.5 μm wide boundaries, separating regions to become active surface, were fabricated using lithography, such that each region was a 1 mm wide strip that traversed the length of the wafer. 1 nm of Fe was then deposited on these regions using electron beam deposition, and then the photoresist mask was lifted off.

The wafer was then coated with a protective photoresist layer for dicing. The wafer was diced in directions parallel (at 15 mm intervals) and perpendicular (at 20 mm intervals) to the boundaries, such that each die had approximately 14 rectangular regions of active surface, each region being 20 mm (the die length) by 1 mm (as defined by the lithography boundaries). The photoresist was then stripped and the dies were cleaned.

Arrays of carbon nanotubes were grown in the regions at 800° C. for 30 minutes under conditions previously described. The arrays of nanotubes were separated in-situ, by etching the interface between the nanotubes and the substrate using the etching procedure previously described.

The density of a representative undensified (as-grown and as-separated) portion of an array was determined by measuring the physical dimensions of the portion using scanning electron microscopy (JEOL JSM 6301F) and weighing the sample (Mettler Toledo AG104). As-grown densities were typically 0.01-0.02 g/cc.

Several portions were exposed to a wetting environment by gently pushing the portions off of the substrate and into an isopropanol bath. The resulting wet portions were captured on a glass cover slip substrate such that the alignment direction of the nanotubes was parallel to the surface of the substrate. The ends of each portion were affixed using a small weight to prevent warping during drying. Each wet portion was allowed to dry at ambient temperature and pressure. Density measurements of 16 portions subsequent to drying resulted in an average density of 0.4 g/cc.

The above description is illustrative and not restrictive. Many variations of the invention will become apparent to those of skill in the art upon review of this disclosure. For example, the blocks shown in FIGS. 4B and 6 are simple examples that can readily be replaced by other objects that provide the necessary forces and constraining surfaces. The scope of the invention should, therefore, be determined not with reference to the above description, but instead should be determined with reference to the appended claims along with their full scope of equivalents.

What is claimed is:

1. A method for forming nanotubes into a freestanding object, the method comprising:
providing a substrate having a surface;
growing an array of substantially aligned nanotubes on the surface, the array characterized by a height in a direction normal to the surface;
separating at least a portion of the array from the surface to form a separated portion; and
densifying the separated portion to form the freestanding object.

2. The method of claim 1, wherein providing the substrate includes forming a catalyst layer on the surface.

3. The method of claim 2, wherein forming the catalyst layer includes patterning the catalyst layer into a region on the surface characterized by a length in a direction parallel to the surface.

4. The method of claim 3, wherein growing the array includes growing until a ratio of the height to the length is greater than 1:1.

5. The method of claim 1, wherein separating at least the portion includes applying a mechanical force to the portion.

6. The method of claim 1, wherein separating at least the portion includes etching.

7. The method of claim 1, wherein densifying the separated portion includes mechanically compacting the separated portion.

8. The method of claim 1, wherein densifying the separated portion includes applying a force in a direction substantially perpendicular to a direction of alignment of the nanotubes.

9. The method of claim 1, wherein densifying the separated portion includes applying a force in a direction substantially parallel to a direction of alignment of the nanotubes.

10. The method of claim 1, wherein densifying the separated portion includes constraining one or more surfaces of the separated portion.

11. The method of claim 1, wherein the steps of separating and densifying are performed at approximately the same time.

12. The method of claim 1, wherein densifying the separated portion includes wetting the separated portion and drying the separated portion.

13. The method of claim 12, wherein wetting the separated portion includes exposing the separated portion to a fluid including a surfactant.

14. The method of claim 12, wherein wetting comprises exposing the separated portion to a vapor or mist.

15. The method of claim 12, wherein wetting includes immersing the separated portion in a fluid.

16. The method of claim 12, wherein drying includes constraining one or more surfaces of the separated portion.

17. The method of claim 1, wherein the separated portion is characterized by a length in a direction perpendicular to an alignment direction of the nanotubes, the length being between 100 microns and 10 centimeters.

18. The method of claim 18, wherein a ratio of the height to the length is greater than 1:1.

19. The method of claim 1, wherein densifying the separated portion includes mechanically compacting the portion, wetting the portion, and drying the portion.

20. A method for forming nanotubes into a first object, the method comprising:
forming a plurality of second objects, each of the second objects fabricated by providing a substrate including a surface,
growing an array of substantially aligned nanotubes on the surface, the array characterized by a height in a direction normal to the surface,
separating at least a portion of the array from the surface to form a separated portion, and
densifying the separated portion to form the second object; and
assembling the plurality of second objects together to form the first object.

21. The method of claim 20, further comprising trimming the first object.

22. The method of claim 20, further comprising trimming at least one of the second objects.

23. The method of claim 20, wherein assembling includes the use of a glue or an adhesive.

24. A freestanding object, comprised of at least 10% nanotubes by mass, having a volume of greater than 5 cubic millimeters.

25. The freestanding object of claim 24, comprising at least 90% nanotubes by mass and a density greater than 0.4 grams/cc.
